(19) United States
(12) Patent Application Publication
(10) Pub. No.: US 2013/0273913 A1
(43) Pub. Date: Oct. 17, 2013

(54) SYSTEMS AND METHODS FOR EFFICIENT WIRELESS SYSTEM SCANNING

(71) Applicant: QUALCOMM INCORPORATED, San Diego, CA (US)

(72) Inventors: Arvind SWAMINATHAN, San Diego, CA (US); Rajeev PAL, San Diego, CA (US); Nam Soo PARK, San Diego, CA (US); Rajeev Subhash KURUNDKAR, Telecom Nagar (IN); Yonas S. KIDANE, San Diego, CA (US); Srinivasan BALASUBRAMANIAN, San Diego, CA (US); Jimin HA, San Diego, CA (US); Mark F. SLOANE, La Jolla, CA (US); Manasi D. GANDHI, San Diego, CA (US)

(73) Assignee: QUALCOMM INCORPORATED, San Diego, CA (US)

(21) Appl. No.: 13/844,167

(22) Filed: Mar. 15, 2013

Related U.S. Application Data
(60) Provisional application No. 61/624,134, filed on Apr. 13, 2012.
(60) Provisional application No. 61/657,289, filed on Jun. 8, 2012.

(51) Int. Cl. H04W 48/16

(52) U.S. Cl. CPC H04W 48/16
USPC 455/434

(57) ABSTRACT

A method for scanning for wireless systems is described. The method includes camping on a first system of a first system type. The method also includes maintaining a second system type not available list. The method additionally includes maintaining a second system type available list. The method further includes detecting a scan trigger. The method also includes determining whether the first system is in the second system type not available list. The method additionally includes scanning for second system type systems based on a timer.

### RELATED APPLICATIONS

This application is related to and claims priority from U.S. Provisional Patent Application Ser. No. 61/624,134, filed Apr. 13, 2012, for “LONG TERM EVOLUTION (LTE) BETTER SYSTEM RESELECTION (BSR) OPTIMIZATION” and is related to and claims priority from U.S. Provisional Patent Application Ser. No. 61/657,289, filed Jun. 8, 2012, for “LONG TERM EVOLUTION (LTE) BETTER SYSTEM RESELECTION (BSR) OPTIMIZATION.”

### TECHNICAL FIELD

The present disclosure relates generally to communication systems. More specifically, the present disclosure relates to systems and methods for efficient wireless system scanning (e.g., network scanning)

### BACKGROUND

Communication systems are widely deployed to provide various types of communication content such as data, voice, video and so on. These systems may be multiple-access systems capable of supporting simultaneous communication of multiple communication devices (e.g., wireless communication devices, access terminals, etc.) with one or more other communication devices (e.g., base stations, access points, etc.). Some communication devices (e.g., access terminals, laptop computers, smart phones, media players, gaming devices, etc.) may wirelessly communicate with other communication devices.

In the last several decades, the use of wireless communication devices has become common. In particular, advances in electronic technology have reduced the cost of increasingly complex and useful wireless communication devices. Cost reduction and consumer demand have proliferated the use of wireless communication devices such that they are practically ubiquitous in modem society. As the use of wireless communication devices has expanded, so has the demand for new and improved features of wireless communication devices.

As wireless communication devices have become more widely deployed, the number of communication systems available has also increased. However, inefficiencies may arise when scanning for communication systems. Accordingly, systems and methods that may help to reduce these inefficiencies may be beneficial.

### SUMMARY

A method for scanning for wireless systems is described. The method includes camping on a first system of a first system type. The method also includes maintaining a second system type not available list. The method further includes maintaining a second system type available list. The method additionally includes detecting a scan trigger. The method also includes determining whether the first system is in the second system type not available list. The method further includes scanning for second system type systems based on a timer.

The scan trigger may be selected from a group consisting of a call end, an idle handover, a power-up, an out-of-service change, and a mode change. If the first system is in the second system type not available list, then the method may further include triggering the timer with a first period. The scan may be performed upon expiration of the first period. The method may include determining whether the timer has expired before triggering the timer. If the first system is not in the second system type not available list, then the method may further include performing an immediate scan for second system type systems.

If a system of the second system type is found, then the method may also include adding the first system to the top of the second system type available list. The method may further include triggering the timer with a first period. A second scan may be performed upon expiration of the first period. The method may also include removing the first system from the second system type not available list.

If a system of the second system type is found, then the method may also include determining whether the first system is in the second system type available list. The method may further include moving the first system to the top of the second system type available list. The method may additionally include triggering the timer with a first period. A second scan may be performed upon expiration of the first period.

If a system of the second system type is not found, then the method may also include determining whether the first system is in the second system type available list. If the first system is in the second system type available list, then the method may further include triggering the timer with a first period. A second scan may be performed upon expiration of the first period.

If the first system is not in the second system type available list, then the method may also include adding the first system to the top of the second system type not available list. The method may further include triggering the timer with a second period. A second scan may be performed upon expiration of the second period.

The second system type not available list may include a count field. The method may also include determining whether the count field is less than a configuration parameter corresponding to a maximum number of scan failures. If the count field is less than the configuration parameter, then the method may further include incrementing the count field. The method may additionally include triggering the timer with a first period. The scan may be performed upon expiration of the first period. If the count field is not less than the configuration parameter, then the method may also include triggering the timer with a second period. The scan may be performed upon expiration of the second period.

The method may be performed by a wireless communication device. The first system type may be 1× and the second system type may be long term evolution (LTE). The scan may include a better system reselection scan.

A wireless communication device for scanning for wireless systems is also described. The wireless communication device includes a processor, memory in electronic communication with the processor and instructions stored in the memory. The instructions are executable by the processor to camp on a first system of a first system type. The instructions are also executable to maintain a second system type not available list. The instructions are further executable to maintain a second system type available list. The instructions are additionally executable to detect a scan trigger. The instructions are also executable to determine whether the first system is in the second system type not available list. The instructions are further executable to scan for second system type systems based on a timer.

A computer-program product for scanning for wireless systems is also described. The computer-program product includes a non-transitory tangible computer-readable medium with instructions. The instructions include code for causing a wireless communication device to camp on a first system of a first system type. The instructions also include code for causing a wireless communication device to maintain a second system type not available list. The instructions further include code for causing a wireless communication device to maintain a second system type available list. The instructions additionally include code for causing a wireless communication device to detect a scan trigger. The instructions also include code for causing a wireless communication device to determine whether the first system is in the second system type not available list. The instructions further include code for causing a wireless communication device to scan for second system type systems based on a timer.

An apparatus for scanning for wireless systems is also described. The apparatus includes means for camping on a first system of a first system type. The apparatus also includes means for maintaining a second system type not available list. The apparatus further includes means for maintaining a second system type available list. The apparatus additionally includes means for detecting a scan trigger. The apparatus also includes means for determining whether the first system is in the second system type not available list. The apparatus further includes means for scanning for second system type systems based on a timer.

### BRIEF DESCRIPTION OF THE DRAWINGS

FIG. 1 is a block diagram illustrating one configuration of a wireless communication device, a first system type base station and a second system type base station in which systems and methods for efficient wireless system scanning may be implemented;

FIG. 2 is a flow diagram illustrating one configuration of a method for efficient wireless system scanning;

FIG. 3 is a block diagram illustrating one configuration of a first wireless communication device and a second wireless communication device in which systems and methods for efficient wireless system scanning may be implemented;

FIG. 4 is a flow diagram illustrating a more specific configuration of a method for efficient wireless system scanning;

FIG. 5 is an example of a scan timeline in which a wireless communication device camps on systems in the second system type available list;

FIG. 6 is an example of two scan timelines where a wireless communication device switches from no service to camping on a system that is listed in the second system type not available list and where a wireless communication device switches from no service to camping on a system that is not listed in the second system type not available list;

FIG. 7 is an example of a scan timeline during transitions from a system that is listed in the second system type available list to a system that is listed in the second system type not available list and then to another system that is also listed in the second system type not available list;

FIG. 8 is a block diagram illustrating one configuration of a wireless communication device, a 1× base station and a Long Term Evolution (LTE) base station in which systems and methods for efficient wireless system scanning may be implemented;

FIG. 9 is a flow diagram illustrating an even more specific configuration of a method for efficient wireless system scanning; and

FIG. 10 illustrates certain components that may be included within a wireless communication device.

### DETAILED DESCRIPTION

Examples of communication devices include cellular telephone base stations or nodes, access points, wireless gateways and wireless routers. A communication device may operate in accordance with certain industry standards, such as Third Generation Partnership Project (3GPP) Long Tenn Evolution (LTE) standards. Other examples of standards that a communication device may comply with include Institute of Electrical and Electronics Engineers (IEEE) 802.11a, 802.11b, 802.11g, 802.11n and/or 802.11ac (e.g., Wireless Fidelity or “Wi-Fi”) standards, IEEE 802.16 (e.g., Worldwide Interoperability for Microwave Access or “WiMAX”) standards, Third Generation Partnership Project 2 (3GPP2) Code Division Multiple Access (CDMA) 2000 1× (referred to herein as “1×”, may also be referred to as IS-2000 or 1×RTT) standards, 3GPP2 Evolution-Data Optimized (EVDO) standards, Interim Standard 95 (IS-95), High Rate Packet Data (HRPD), evolved High Rate Packet Data (eHRPD) radio standards and others. In some standards, a communication device may be referred to as a Node B, evolved Node B, etc. While some of the systems and methods disclosed herein may be described in terms of one or more standards, this should not limit the scope of the disclosure, as the systems and methods may be applicable to many systems and/or standards.

Some communication devices (e.g., access terminals, client devices, client stations, etc.) may wirelessly communicate with other communication devices. Some communication devices (e.g., wireless communication devices) may be referred to as mobile devices, mobile stations, subscriber stations, clients, client stations, user equipment (UEs), remote stations, access terminals, mobile terminals, terminals, user terminals, subscriber units, etc. Additional examples of communication devices include laptop or desktop computers, cellular phones, smart phones, wireless modems, e-readers, tablet devices, gaming systems, etc. Some of these communication devices may operate in accordance with one or more industry standards as described above. Thus, the general term “communication device” may include communication devices described with varying nomenclatures according to industry standards (e.g., access terminal, user equipment, remote terminal, access point, base station, Node B, evolved Node B, etc.).

The terms “networks” and “systems” are often used interchangeably. A CDMA network may implement a radio access technology (RAT) such as Universal Terrestrial Radio Access (UTRA), CDMA2000, etc. UTRA includes wideband CDMA (W-CDMA) and Low Chip Rate (LCR) while CDMA2000 covers IS-2000, IS-95 and IS-856 standards. A Time Division Multiple Access (TDMA) network may implement a radio access technology (RAT) such as Global System for Mobile Communications (GSM). An Orthogonal Frequency Division Multiple Access (OFDMA) network may implement a radio access technology (RAT) such as Evolved UTRA (E-UTRA), IEEE 802.11, IEEE 802.16, IEEE 802.20, Flash-OFDMA, etc. UTRA, E-UTRA and GSM are part of Universal Mobile Telecommunication System (UMTS). Long Term Evolution (LTE) is a release of UMTS that uses E-UTRA. UTRA, E-UTRA, GSM, UMTS and Long Term Evolution (LTE) are described in documents from an organization named “3rd Generation Partnership Project” (3GPP). Additionally, CDMA2000 is described in documents from an organization named “3rd Generation Partnership Project 2” (3 GPP2).

As used herein, the term “system” may refer to a system, a telecommunication system, a mobile telecommunication system, a network, a communication network, etc. Additionally, as used herein, the term “system” may refer to a radio access technology (RAT) that may be implemented within a particular system.

The standards described above may be referred to as system types, where each standard is a different system type. One example of a first system type may be a system that operates in accordance with the 1× standard Similarly, one example of a second system type may be a system that operates in accordance with the LTE standard.

There are many situations in which the system selection procedures of a wireless communication device may benefit from knowledge of communication systems that are most likely to be found in a given location. For example, the systems and methods disclosed herein may improve better system reselection (BSR) scans. By optimizing when a wireless communication device may scan for preferred systems, the wireless communication device may reduce power consumption and increase battery life.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods. Features and/or elements described in connection with a Figure may be combined with one or more features and/or elements described in connection with one or more other Figures.

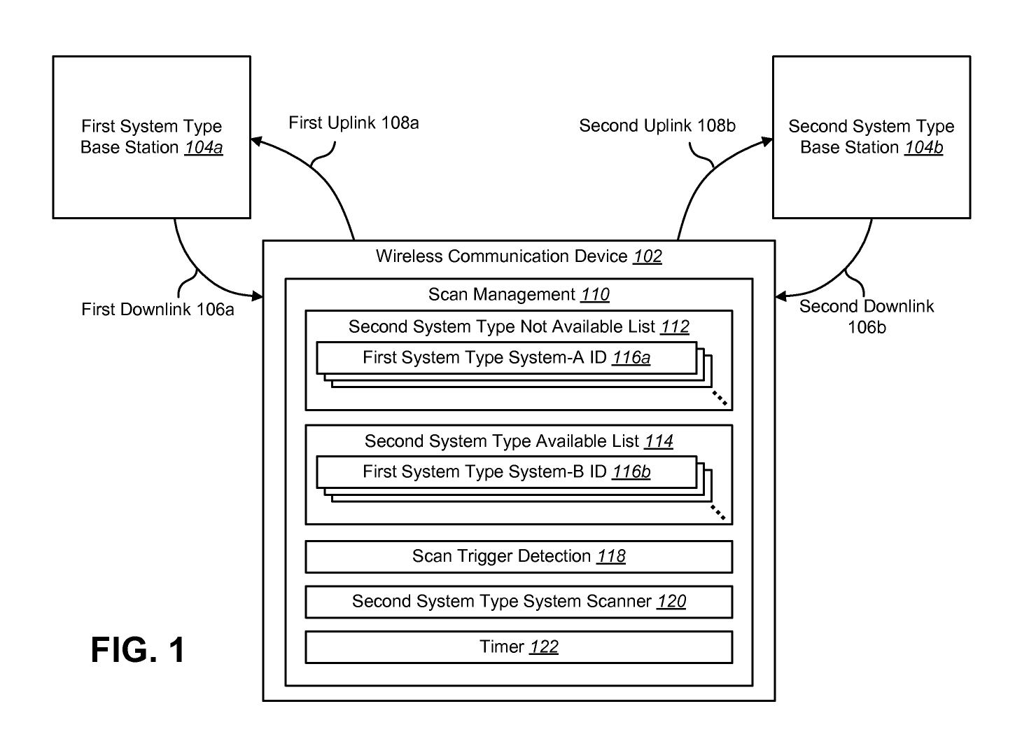

FIG. 1 is a block diagram illustrating one configuration of a wireless communication device 102, a first system type base station 104a and a second system type base station 104b in which systems and methods for efficient wireless system scanning may be implemented. A base station 104 is a device that may communicate with one or more wireless communication devices 102. A base station 104 may also be referred to as, and may include some or all of the functionality of, an access point, a broadcast transmitter, a NodeB, an evolved NodeB (eNB), etc. Each base station 104 may provide communication coverage for a particular geographic area. A base station 104 may provide communication coverage for one or more wireless communication devices 102. The term “cell” may refer to a base station 104 and/or its coverage area depending on the context in which the term is used. Examples of the base station 104 include cellular phone base stations, access points, etc.

A base station 104 may use one or more system types to communicate with a wireless communication device 102. In one configuration, the first system type base station 104a may communicate with the wireless communication device 102 using the 1× system type. The second system type base station 104b may communicate with the wireless communication device 102 using the LTE system type. It should be noted that a base station 104 may communicate with the wireless communication device 102 using more than one system type. For example, a base station 104 may communicate with the wireless communication device 102 using both 1× and LTE on separate channels.

The wireless communication device 102 may also be referred to as, and may include some or all of the functionality of, a terminal, an access terminal, a subscriber unit, a station, a user equipment (UE), etc. Examples of the wireless communication device 102 may include a cellular phone, a personal digital assistant (PDA), a wireless device, a wireless modem, a handheld device, a laptop computer, a Session Initiation Protocol (SIP) phone, a wireless local loop (WLL) station, etc.

A wireless communication device 102 may communicate with one or more base stations 104 on a downlink 106 and/or an uplink 108 at any given moment. For example, the wireless communication device 102 may communicate with the first system type base station 104a on a first downlink 106a and/or a first uplink 108a. The wireless communication device 102 may also communicate with the second system type base station 104b on a second downlink 106b and/or a second uplink 108b. The downlink 106 (or forward link) refers to the communication link from a base station 104 to a wireless communication device 102, and the uplink 108 (or reverse link) refers to the communication link from a wireless communication device 102 to a base station 104.

Communications between the wireless communication device 102 and base stations 104a-b may be achieved through transmissions over a wireless link. Such a communication link may be established via a single-input and single-output (SISO), multiple-input and single-output (MISO) or a multiple-input and multiple-output (MIMO) system. A multiple-input and multiple-output system includes transmitter(s) and receiver(s) equipped, respectively, with multiple (N_{T}) transmit antennas and multiple (N_{R}) receive antennas for data transmission. Single-input and single-output and multiple-input and single-output systems are particular instances of a multiple-input and multiple-output (MIMO) system. The multiple-input and multiple-output (MIMO) system can provide improved performance (e.g., higher throughput, greater capacity or improved reliability) if the additional dimensionalities created by the multiple transmit and receive antennas are utilized.

Oftentimes, a wireless communication device 102 may be geographically located in an area where the wireless communication device 102 can obtain coverage from both a first system type base station 104a and a second system type base station 104b. It may be desirable that the wireless communication device 102 obtain coverage from the second system type base station 104b in addition to and/or instead of the first system type base station 104a. In some configurations, whenever the wireless communication device 102 is receiving coverage from a first system type base station 104a, the wireless communication device 102 may periodically scan (e.g., search) for second system type base station 104b if the second system type is preferred over the first system type. This may be because of high data rates associated with second system type base station 104b.

In one configuration, the first system type may be a 1× system type and the second system type may be an LTE system type. If the wireless communication device 102 searches for LTE systems, this search may be referred to as an LTE scan. An LTE scan may be one specific type of scan of a better system reselection (BSR) scan. In general, a wireless communication device 102 may perform a BSR scan periodically to search for systems that provide some benefit or are preferred over the current system. While a BSR scan is described, it should be noted that the wireless communication device 102 may perform different types of scans that are within the scope of the disclosed systems and methods.

Although a second system type may be preferred, second system type systems may not be available in many areas while the wireless communication device 102 is camped on (e.g., connected to) a first system type system. For example, in some configurations, the deployments of the second system type may be concentrated in certain locations (e.g., hotspots). Within these areas, there is a high likelihood that the wireless communication device 102 may find and connect to the preferred second system type base station 104b. However, outside the second system type hotspots, it may be unlikely that the wireless communication device 102 will find a second system type system. Therefore, it may be desirable to slow down the frequency of scans for second system type systems in regions where the likelihood of finding a second system type system is low. By reducing the number of scans performed, the wireless communication device 102 may reduce power consumption and increase battery life.

In the context of LTE, with current approaches it may be difficult to indicate (by a base station 104 to the wireless communication device 102, for instance) LTE availability in a fine-grained fashion. Therefore, a wireless communication device 102 typically scans for preferred LTE systems instead of relying on received indicators from a base station 104. However, outside the LTE hotspots, the likelihood that the wireless communication device 102 will find an LTE system may be low. Therefore, it may be desirable to slow down the frequency of LTE scans in regions where the likelihood of finding an LTE system is low.

The wireless communication device 102 may include a scan management block/module 110. The scan management block/module 110 may include a second system type not available list 112, a second system type available list 114, a scan trigger detection block/module 118, a system scanner block/module 120 and/or a timer block/module 122. As used herein, the term “block/module” may indicate that a particular element may be implemented in hardware, software, firmware or any combination thereof. For example, the scan management block/module 110 may be implemented in hardware (e.g., circuitry), software or a combination of both. It should also be noted that one or more of the elements illustrated in FIG. 1 may be implemented in circuitry (e.g., integrated circuitry) in some configurations.

The wireless communication device 102 may maintain a second system type not available list 112 and a second system type available list 114. These lists 112, 114 may be maintained on the wireless communication device 102 (e.g., stored in memory on the wireless communication device 102). Each list 112, 114 may include entries 116a-b corresponding to first system type base stations 104a. In one configuration, the second system type not available list 112 may include a first system type system-A ID 116a and/or other first system type system IDs 116. The second system type available list 114 may include a first system type system-B ID 116b and/or other first system type system IDs 116. Each first system type system ID 116a-b may include identifying information for a particular first system type base station 104a. In one configuration, a first system type system ID 116 may include a combination of system ID (SID), network ID (NID) and/or base station ID (BASE_ID). It should be noted that although the second system type not available list 112 and the second system type available list 114 are described as lists, a database structure may be used to implement the second system type not available list 112 and the second system type available list 114.

The first system type system IDs 116 may be ordered in a most-recently used fashion. For example, the first system type system ID-A 116a may be the most recent entry to the second system type not available list 112. Therefore, the first system type system ID-A 116a may be added to the top of the second system type not available list 112.

The second system type not available list 112 may include entries corresponding to first system type base stations 104a where the wireless communication device 102 has camped, but a scan for second system type systems while camped on the first system type system has never found a second system type base station 104b. In other words, the second system type not available list 112 may be a list of first system type base stations 104a that the wireless communication device 102 is currently or has previously camped on and from which the wireless communication device 102 has never been able to find second system type base station 104b.

The second system type available list 114 may include entries corresponding to first system type base stations 104a where the wireless communication device 102 has camped and a scan for second system type systems has found a second system type base station 104b. In other words, the second system type available list 114 may include a list of first system type base stations 104a that the wireless communication device 102 has previously camped on and from which the wireless communication device 102 has been able to find second system type base station 104b.

The scan trigger detection block/module 118 may detect one or more scan triggers that indicate to the wireless communication device 102 that the wireless communication device 102 should perform a scan for a preferred second system type base station 104b. The scan triggers may include a call end, an idle handover, a power-up of the wireless communication device 102, an out-of-service change and/or a mode change. Upon detecting a scan trigger, the wireless communication device 102 may determine whether to perform a scan for a preferred second system type base station 104b according to the systems and methods described herein.

If the wireless communication device 102 is camped on a first system type base station 104a, upon detecting a scan trigger, the wireless communication device 102 may determine if the first system type base station 104a is listed in the second system type not available list 112. If the first system type base station 104a is not listed in the second system type not available list 112, the second system type system scanner 120 may immediately scan for more preferred second system type base stations 104b. The wireless communication device 102 may then periodically scan for more preferred second system type base stations 104b. The scans may be repeated after a first period (e.g., scan delay period). For example, the wireless communication device 102 may start a timer 122 and scan for second system type base stations 104b upon the expiration of the timer 122.

However, if the wireless communication device 102 is camped on a first system type base station 104a, and upon detecting a scan trigger, the wireless communication device 102 determines that the first system type base station 104a is included in the second system type not available list 112, the wireless communication device 102 may perform a scan for second system type systems based on the timer 122. For example, in this scenario (where the first system type base station 104a is listed in the second system type not available list 112) the wireless communication device 102 has never found a second system type base station 104b while camped on the first system type base station 104a. Therefore, instead of performing an immediate scan for second system type base stations 104b, the wireless communication device 102 may trigger the timer 122 with a second period. Upon the expiration of the timer 122, the wireless communication device 102 may perform the scan for second system type base stations 104b. The second period may be longer than the first period. Therefore, if the wireless communication device 102 detects a scan trigger for second system type base stations 104b, the wireless communication device 102 may only perform the immediate scan if camped on a first system type base station 104a that is not in the second system type not available list 112.

If the wireless communication device 102 camps on a first system type base station 104a that is not included in either the second system type not available list 112 or the second system type available list 114, the wireless communication device 102 may perform an immediate scan for second system type base stations 104b. This scenario may occur if the wireless communication device 102 has never camped on the first system type base station 104a, and/or has no record of this base station 104a. If a second system type base station 104b is discovered, the first system type system ID 116 may be placed at the top of the second system type available list 114. Alternatively, if a second system type base station 104b is not discovered, the first system type system ID 116 may be placed at the top of the second system type not available list 112.

In one configuration, when a first system type system ID 116 is placed at the top of either the second system type not available list 112 or the second system type available list 114, the least recently used (e.g., oldest) entry may be dropped (if the list 112, 114 is full). For example, if the second system type available list 114 is full and a first system type system ID 116 is added to the second system type available list 114, the least recently used entry may be dropped from the second system type available list 114.

A first system type system ID 116 may be included in either the second system type not available list 112 or the second system type available list 114 at a particular time, but not both. For example, if a first system type system ID 116 for a particular first system type base station 104a is added to the second system type available list 114, then the wireless communication device 102 may remove the first system type system ID 116 for that particular first system type base station 104a from the second system type not available list 112.

In another configuration, only one instance of a first system type system ID 116 for a particular first system type base station 104a may be included in the second system type not available list 112 and the second system type available list 114. For example, if the wireless communication device 102 finds a second system type base station 104b while camped on the first system type base station 104a, and the first system type system ID 116 is already included in the second system type available list 114, the wireless communication device 102 may move the first system type system ID 116 to the top of the second system type available list 114.

In yet another configuration, once a particular first system type base station 104a is entered in the second system type available list 114, that first system type base station 104a may not be moved to the second system type not available list 112, even if subsequent scans fail to find a second system type base station 104b while camped on the first system type base station 104a. Instead, this scan failure may be treated as a temporary failure to find a second system type base station 104b while camped on the first system type base station 104a. It should be noted that the first system type base station 104a may be dropped from the second system type available list 114 if the first system type base station 104a reaches the bottom of the second system type available list 114. If the first system type base station 104a is dropped from the second system type available list 114, the first system type base station 104a may be added to the second system type not available list 112 if a scan fails to find a second system type base station 104b while camped on the first system type base station 104a.

In another configuration, the second system type not available list 112 may include a count field. In this configuration, the count field may be incremented each time a scan fails to find a second system type system. The use of the longer second period for the timer 122 may be based on the count field. For example, the wireless communication device 102 may trigger the timer 122 with a first period while the count field is less than configuration parameter corresponding to a maximum number of scan failures. However, if the count field is not less than the configuration parameter, the wireless communication device 102 may trigger the timer 122 with the second (e.g., longer) period.

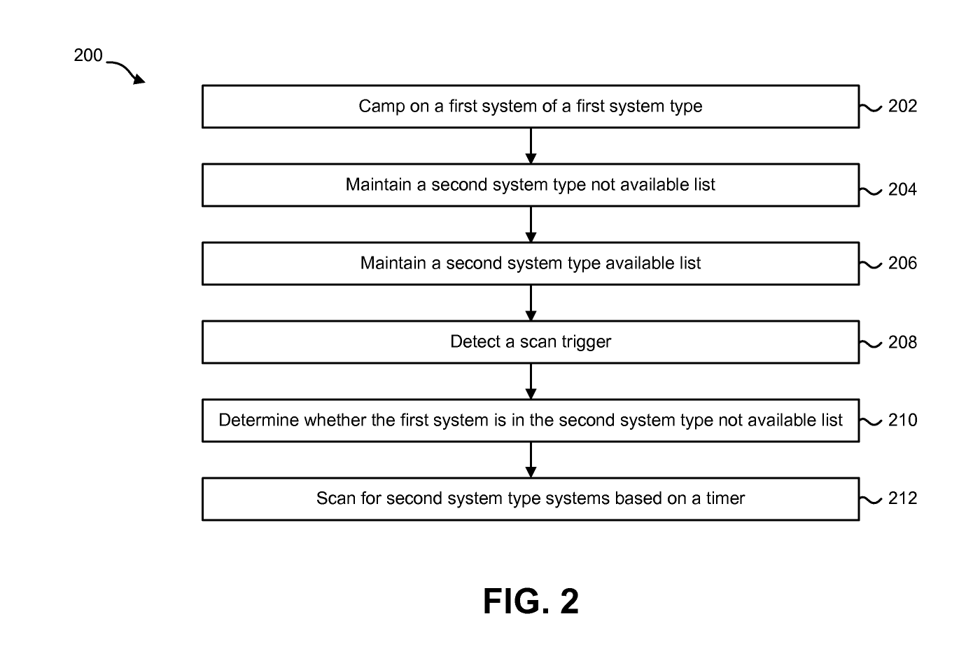

FIG. 2 is a flow diagram illustrating one configuration of a method 200 for efficient wireless system scanning The method 200 may be performed by a wireless communication device 102. For example, the method 200 may be performed by a scan management block/module 110. The wireless communication device 102 may camp 202 on a first system of a first system type. For example, the wireless communication device 102 may be connected to a first system type base station 104a. The first system type may be a 1× system.

The wireless communication device 102 may maintain 204 a second system type not available list 112. The second system type not available list 112 may include entries (e.g., first system type system IDs 116) corresponding to first system type base stations 104a. Each first system type system ID 116 may include identifying information for a particular first system type base station 104a. In one configuration, a first system type system ID 116 may include a combination of system ID (SID), network ID (NID) and/or base station ID (BASE_ID). The second system type not available list 112 may include entries corresponding to first system type base stations 104a where the wireless communication device 102 has camped, but a scan for second system type systems while camped on the first system type system has never found a second system type base station 104b. In other words, the second system type not available list 112 includes first system type systems (e.g., base stations 104a) where a second system type system (e.g., an LTE system) was not found.

The wireless communication device 102 may maintain 206 a second system type available list 114. The second system type available list 114 may include entries corresponding to first system type base stations 104a where the wireless communication device 102 has camped and a scan for second system type systems has found a second system type base station 104b. Therefore, the second system type available list 114 includes first system type systems (e.g., first system type base stations 104a) where a second system type was found.

The wireless communication device 102 may detect 208 a scan trigger. For example, the wireless communication device 102 may detect one or more scan triggers that indicate to the wireless communication device 102 that the wireless communication device 102 should perform a scan for a preferred second system type base station 104b. The scan triggers may include a call end, an idle handover, a power-up of the wireless communication device 102, an out-of-service change and/or a mode change.

The wireless communication device 102 may determine 210 whether the first system is in the second system type not available list 112. For example, the wireless communication device 102 may search the second system type not available list 112 for a first system type system ID 116 corresponding to the first system type base station 104a.

The wireless communication device 102 may scan 212 for second system type systems based on a timer 122. For example, if the wireless communication device 102 determines 210 that the first system is not in the second system type not available list 112, the wireless communication device 102 may immediately scan 212 for second system type systems. The wireless communication device 102 may then periodically scan for second system type systems. The scans 212 may be repeated after a first period (e.g., scan delay period). For example, the wireless communication device 102 may start a timer 122 and scan 212 for second system type systems upon expiration of the timer 122.

However, if the wireless communication device 102 determines 210 that the first system is in the second system type not available list 112, the wireless communication device 102 may trigger the timer 122 with a second period (instead of performing an immediate scan 212 for second system type systems. Upon the expiration of the timer 122, the wireless communication device 102 may scan 212 for second system type systems. The second period may be longer than the first period. Therefore, the wireless communication device 102 may only perform an immediate scan 212 if camped on a first system type base station 104a that is not in the second system type not available list 112.

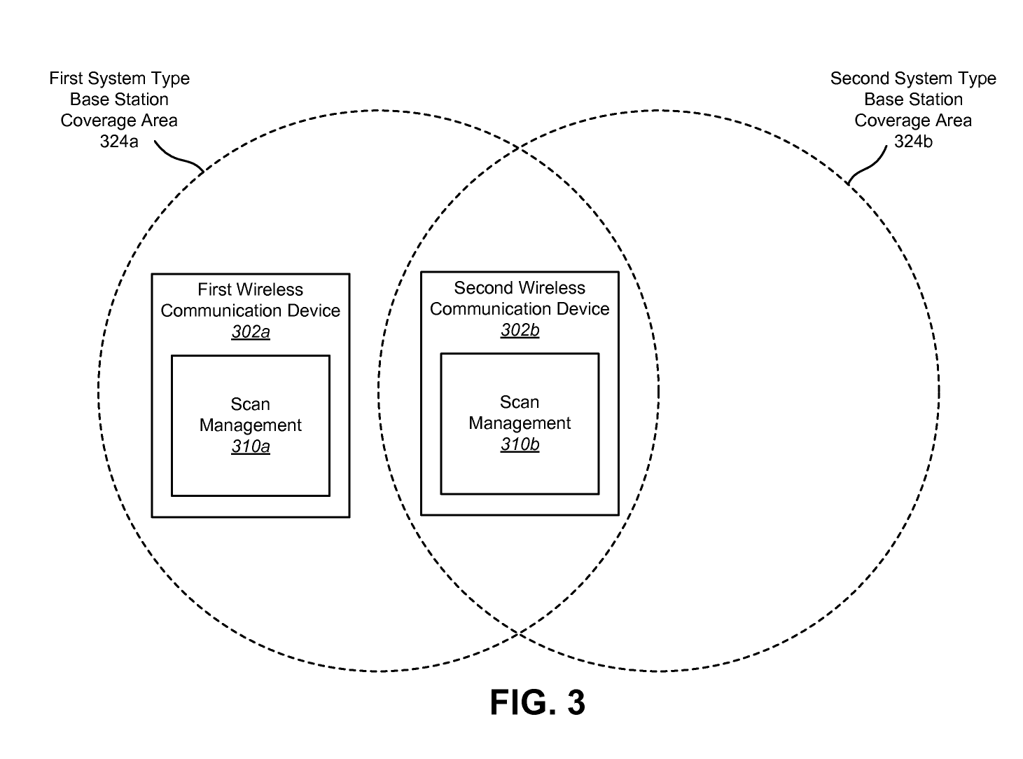

FIG. 3 is a block diagram illustrating one configuration of a first wireless communication device 302a and a second wireless communication device 302b in which systems and methods for efficient wireless system scanning may be implemented. For example, each wireless communication device 302a-b may include a scan management block/module 310a-b for performing efficient wireless system scanning according to the systems and methods described herein. The wireless communication devices 302a-b may be similar to the wireless communication device 102 described in connection with FIG. 1.

The dashed lines in FIG. 3 indicate the coverage areas 324a-b of different base stations 104. While FIG. 3 depicts two base station coverage areas 324a-b, any number of base stations 104 may be available. A first system type base station coverage area 324a may correspond to a first system type base station 104a described in connection with FIG. 1. In one configuration, the first system type base station 104a may be a 1× or EVDO system type. A second system type base station coverage area 324b may correspond to a second system type base station 104b also described in connection with FIG. 1. The second system type base station 104a may be an LTE system type.

In some configurations, the first system type base station coverage area 324a and the second system type base station coverage area 324b may be collocated. In this configuration, the coverage areas 324a-b may be approximately concentric and overlap at or near 100 percent, propagation differences due to transmission frequency notwithstanding. In other configurations, as shown in FIG. 3, the first system type base station coverage area 324a and the second system type base station coverage area 324b may be offset.

In one configuration, the first wireless communication device 302a may be located only in the first system type base station coverage area 324a. The first wireless communication device 302a may be camped on the first system type base station 104a. Because the first wireless communication device 302a is outside the second system type base station coverage area 324b, the first wireless communication device 302a will not find the second system type base station 104b during a scan. Assuming that while camped on the first system type base station 104a the first wireless communication device 302a has never found a second system type base station 104b, the first system type base station 104a may be added and/or moved to the top of a second system type not available list 112.

The second wireless communication device 302b is located in both the first system type base station coverage area 324a and the second system type base station coverage area 324b. The second wireless communication device 302b may be camped on the first system type base station 104a. Because the second wireless communication device 302b is within the second system type base station coverage area 324b, the second wireless communication device 302b may find the second system type base station 104b during a scan. If the second wireless communication device 302b finds the second system type base station 104b while camped on the first system type base station 104a, the second wireless communication device 302b may add and/or move the first system type base station 104a to the top of a second system type available list 114.

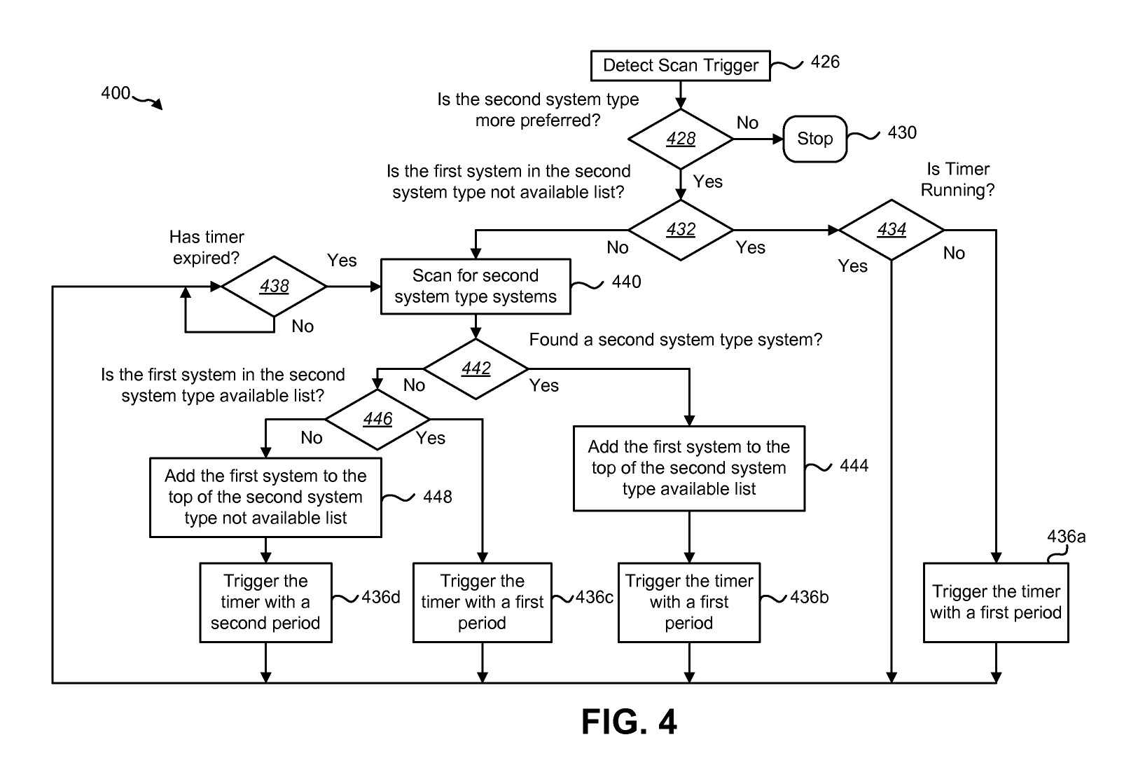

FIG. 4 is a flow diagram illustrating a more specific configuration of a method 400 for efficient wireless system scanning The method 400 may be performed by a wireless communication device 102. The wireless communication device 102 may be camped on a first system of a first system type. For example, the wireless communication device 102 may be connected to a first system type base station 104a. In one configuration, the first system type may be a 1× system type. The wireless communication device 102 may maintain a second system type not available list 112 and a second system type available list 114.

The wireless communication device 102 may detect 426 a scan trigger. The scan trigger may include a call end, an idle handover, a power-up of the wireless communication device 102, an out-of-service change and/or a mode change. The scan trigger may indicate to the wireless communication device 102 that an event or a change in conditions has occurred for which a scan for a second system type base station 104b may be desirable. In this configuration, the second system type may be an LTE system type.

Upon detecting 426 the scan trigger, the wireless communication device 102 may determine 428 whether the second system type is more preferred. If the second system type is not more preferred, then the method 400 stops 430 without the wireless communication device 102 performing a scan for a second system type system. If the second system type is more preferred, then the wireless communication device 102 may determine 432 whether the first system is in the second system type not available list 112. For example, the wireless communication device 102 may determine 432 whether the second system type not available list 112 includes a first system type system ID 116 corresponding to the first system type base station 104a.

If the wireless communication device 102 determines 432 that the first system is in the second system type not available list 112, then the wireless communication device 102 may determine 434 whether a timer 122 is running In one configuration, the timer 122 may have been started in a prior iteration of the method 400. For example, if the wireless communication device 102 moves from the first system of a first system type to a second system of the first system type (e.g., if the wireless communication device 102 moves from a first 1× base station 104 to a second 1× base station 104) the timer 122 may still be running when the wireless communication device 102 camps on the second system. Therefore, to avoid the situation where the timer 122 is repeatedly reset and no scans may occur, the wireless communication device 102 may determine 434 whether the timer 122 is running before resetting the timer 122 with a new period.

If the wireless communication device 102 determines 434 that the timer 122 is running, then the wireless communication device 102 may wait until the timer 122 expires. When the wireless communication device 102 determines 438 that the timer 122 has expired, the wireless communication device 102 may scan 440 for second system type systems. In one configuration, the scan 440 may be a better system reselection (BSR) scan. If the wireless communication device 102 determines 438 that the timer 122 has not expired, then the wireless communication device 102 may wait until the timer 122 expires before scanning 440 for second system type systems.

If the wireless communication device 102 determines 434 that the timer 122 is not running, the wireless communication device 102 may trigger 436a the timer 122 with a first period. The first period may correspond to the amount of time before a scan 440 for second system type systems may be performed. In one configuration, the first period may be the time between conventional BSR scans. A scan 440 for second system type systems may be performed upon the expiration of the timer 122 (e.g., at the expiration of the first period).

If the wireless communication device 102 determines 432 that the first system is not in the second system type not available list 112, then the wireless communication device 102 may perform an immediate scan 440 for second system type systems. In one configuration, the wireless communication device 102 may bypass the timer 122 and perform an immediate scan 440 for second system type systems. In another configuration, the wireless communication device 102 may trigger the timer 122 with an immediate period (e.g., the period for the timer 122 may be set to zero seconds), which will trigger an immediate scan 440 for second system type systems.

Upon scanning 440 for second system type systems, the wireless communication device 102 may determine 442 whether a second system type system is found. If a second system type system (e.g., the second system type base station 104b) is found, then the wireless communication device 102 may add 444 the first system to the top of the second system type available list 114. In one configuration, the wireless communication device 102 may add 444 a first system type system ID 116 to the second system type available list 114. The first system type system ID 116 may include identifying information (e.g., a combination of system ID (SID), network ID (NID) and/or base station ID (BASE_ID)) for a particular first system type base station 104a.

In another configuration, adding 444 the first system to the top of the second system type available list 114 may also include removing the first system from the second system type not available list 112. For example, if the first system was initially in the second system type not available list 112, but a subsequent scan 440 finds a second system type system, the first system may be added 444 to the top of the second system type available list 114 and removed from the second system type not available list 112.

In yet another configuration, adding 444 the first system to the top of the second system type available list 114 may also include moving the first system to the top of the second system type available list 114 if the first system is already in the second system type available list 114. For example, the wireless communication device 102 may determine whether the first system is in the second system type available list 114. If the first system is in the second system type available list 114, the wireless communication device 102 may move the first system to the top of the second system type available list 114.

Upon adding 444 the first system to the top of the second system type available list 114, the wireless communication device 102 may trigger 436b the timer 122 with a first period. A scan 440 for second system type systems may be performed upon the expiration of the timer 122 (e.g., at the expiration of the first period).

If the wireless communication device 102 determines 442 that a second system type system is not found, then the wireless communication device 102 may determine 446 if the first system is in the second system type available list 114. If the first system is in the second system type available list 114, then the wireless communication device 102 may trigger 436c the timer 122 with a first period. In this scenario, the wireless communication device 102 did not find a second system type system during the current scan 440, but a prior scan 440 found a second system type system while camped on the first system. Therefore, because the first system is in the second system type available list 114, the failure to find a second system type system may be treated as a temporary failure to find a second system type system while camped on the first system. A scan 440 for second system type systems may be performed upon the expiration of the timer 122 (e.g., at the expiration of the first period).

If the wireless communication device 102 determines 446 that the first system is not in the second system type available list 114, then the wireless communication device 102 may add 448 the first system to the top of the second system type not available list 112. In one configuration, adding 448 the first system to the top of the second system type not available list 112 may include moving the first system to the top of the second system type not available list 112 if the first system is already included in the second system type not available list 112.

Upon adding 448 the first system to the top of the second system type not available list 112, the wireless communication device 102 may trigger 436d the timer 122 with a second period. It should be noted that the second period may be longer than the first period. For example, the second period may be an amount of time that is longer than the time between conventional BSR scans 440. A scan 440 for second system type systems may be performed upon the expiration of the timer 122 (e.g., at the expiration of the second period).

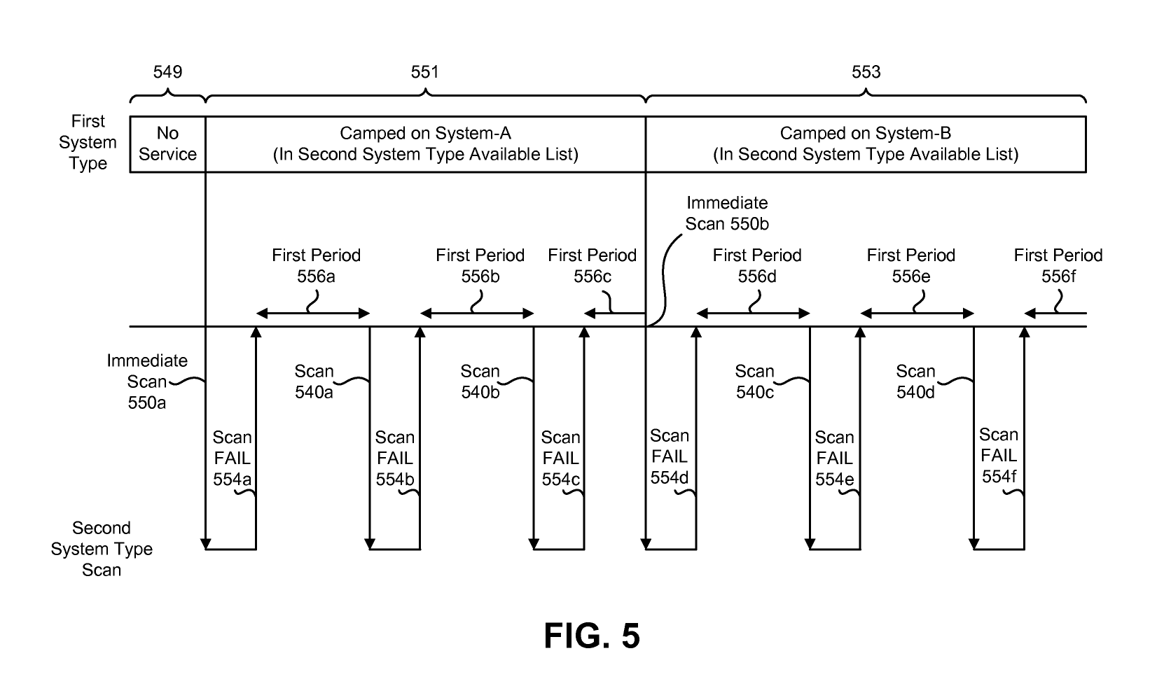

FIG. 5 is an example of a scan timeline in which a wireless communication device 102 camps 551, 553 on systems in the second system type available list 114. During an initial no service period 549, the wireless communication device 102 is not camped on any system. The wireless communication device 102 then camps 551 on system-A, which may be a first system type base station 104a as described in connection with FIG. 1. Upon camping 551 on system-A, the wireless communication device 102 determines that system-A is not in the second system type not available list 112 (because system-A is in the second system type available list 114) and performs an immediate scan 550a for second system type systems. Upon failing 554a to find a second system type system, the wireless communication device 102 determines if system-A is in the second system type available list 114.

Because system-A is in the second system type available list 114, the wireless communication device 102 triggers the timer 122 with a first period 556a. Upon determining that the timer 122 has expired, the wireless communication device 102 scans 540a for second system type systems. Once again, upon failing 554b to find a second system type system, the wireless communication device 102 repeats the scanning cycle, where the timer 122 is triggered with a first period 556b-c after a scan 540b results in a scan failure 554c.

In one configuration, the scan 540 may be a BSR scan. Because system-A is in the second system type available list 114, the scanning cycle may correspond to a conventional BSR scanning cycle. For example, the first period 556 may be the time between scans 540 in conventional BSR scanning

The wireless communication device 102 then camps 553 on system-B. In this configuration, system-B may also be a first system type base station 104a as described in connection with FIG. 1. The switch from system-A to system-B may be a result of the wireless communication device 102 moving from the coverage area 324 of system-A to the coverage area 324 of system-B. Because system-B is also in the second system type available list 114, upon camping 553 in system-B, the wireless communication device 102 performs an immediate scan 550b for second system type systems. As with system-A, upon failing 554d to find any second system type systems while camped 553 on system-B, the wireless communication device 102 repeats a scanning cycle. This scanning cycle includes triggering the timer 122 with a first period 556d-f after a scan 540c-d results in a scan failure 554e-f.

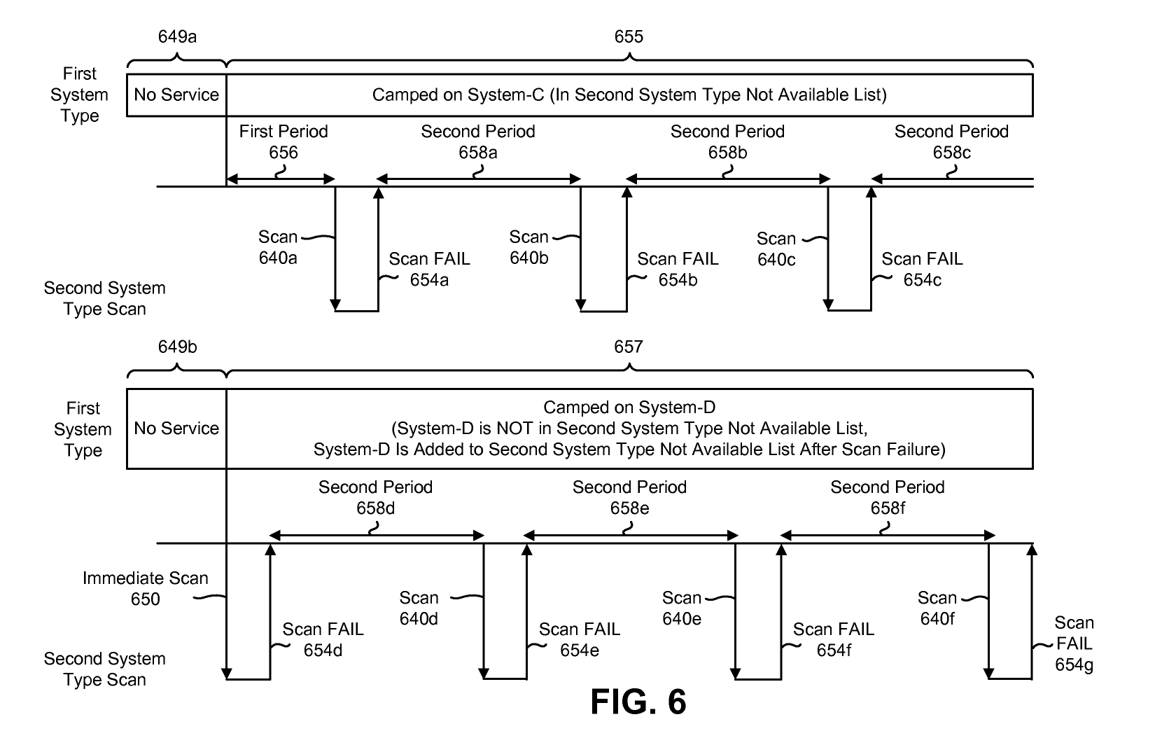

FIG. 6 is an example of two scan timelines where a wireless communication device 102 switches from no service 649a to camping 655 on a system that is listed in the second system type not available list 112 and where a wireless communication device 102 switches from no service 649b to camping 657 on a system that is not listed in the second system type not available list 112. In one configuration, the wireless communication device 102 switches from no service 649a to camping 655 on system-C. In this configuration, system-C is in the second system type not available list 112.

The wireless communication device 102 determines whether system-C is in the second system type not available list 112. Because system-C is in the second system type not available list 112, the wireless communication device 102 then determines whether a timer 122 is running In this example, because the wireless communication device 102 just switched from no service 649a, the timer 122 is not running Therefore, the wireless communication device 102 triggers the timer 122 with a first period 656.

Upon determining that the timer 122 has expired (e.g., the first period 656 has ended), the wireless communication device 102 scans 640a for second system type systems. Upon failing 654a to find a second system type system, the wireless communication device 102 determines if system-C is in the second system type available list 114. In this example, system-C is not in the second system type available list 114. Therefore, system-C is added (e.g., moved) to the top of the second system type not available list 112.

The wireless communication device 102 then triggers the timer 122 with a second period 658a. In this example, the second period 658 is longer than the first period 656. Upon determining that the timer 122 has expired (e.g., the second period 658a has ended), the wireless communication device 102 scans 640b for second system type systems. Once again, upon failing 654b to find a second system type system, the wireless communication device 102 repeats the scanning cycle, where the timer 122 is triggered with a second period 658b-c after a scan 640c results in a scan failure 654c.

In another configuration, the wireless communication device 102 switches from no service 649b to camping 657 on system-D. In this configuration, system-D is not listed in the second system type not available list 112. Additionally, system-D is not listed in the second system type available list 114. This scenario may occur if the wireless communication device 102 has never camped 657 on system-D before.

The wireless communication device 102 determines whether system-D is in the second system type not available list 112. Because system-D is not in the second system type not available list 112, the wireless communication device 102 performs an immediate scan 650 for second system type systems. Upon failing 654d to find a second system type system, the wireless communication device 102 determines if system-D is in the second system type available list 114. In this example, system-D is not in the second system type available list 114. Therefore, system-D is added to the top of the second system type not available list 112.

The wireless communication device 102 then triggers the timer 122 with a second period 658d. Upon determining that the timer 122 has expired (e.g., the second period 658d has ended), the wireless communication device 102 again scans 640d for second system type systems. A scanning cycle based on the second period 658e-f then repeats, where the timer 122 is triggered with the second period 658e-f after a scan 640e-f results in a scan failure 654f-g.

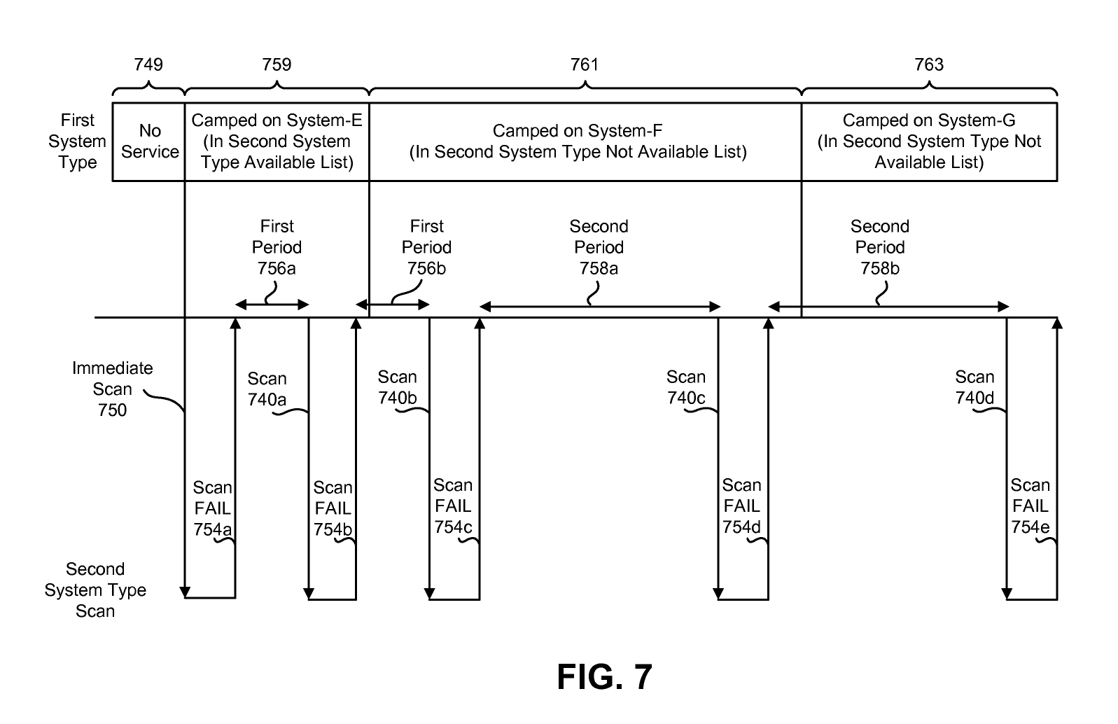

FIG. 7 is an example of a scan timeline during transitions from a system that is listed in the second system type available list 114 to a system that is listed in the second system type not available list 112 and then to another system that is also listed in the second system type not available list 112. In this example, the wireless communication device 102 switches from no service 749 to camping 759 on system-E. In this example, system-E is in the second system type available list 114.

The wireless communication device 102 determines that system-E is not in the second system type not available list 112 and performs an immediate scan 750 for second system type systems. Upon failing 754a to find a second system type system, the wireless communication device 102 determines if system-A is in the second system type available list 114. Because system-E is in the second system type available list 114, the wireless communication device 102 triggers the timer 122 with a first period 756a. Upon determining that the timer 122 has expired, the wireless communication device 102 scans 740a for second system type systems. Once again, upon failing 754b to find a second system type system, the wireless communication device 102 again triggers the timer 122 with a first period 756b.

Before the first period 756b expires, the wireless communication device 102 camps 761 on system-F. In this example, system-F is in the second system type not available list 112. Upon determining that system-F is in the second system type not available list 112, the wireless communication device 102 then determines whether the timer 122 is running. At this point, the timer 122 is still running Upon determining that the timer 122 has expired (e.g., when the first period 756b ends), the wireless communication device 102 scans 740b for second system type systems. Upon failing 754c to find a second system type system, the wireless communication device 102 determines if system-F is in the second system type available list 114. Because system-F is not in the second system type available list 114, the wireless communication device 102 adds (e.g., moves) system-F to the top of the second system type not available list 112. The wireless communication device 102 then triggers the timer 122 with a second period 758a.

Upon determining that the timer 122 has expired, the wireless communication device 102 scans 740c for second system type systems. Once again, upon failing 754d to find a second system type system, the wireless communication device 102 again triggers the timer 122 with a second period 758b.

Before the second period 758b expires, the wireless communication device 102 camps 763 on system-G. In this example, system-G is in the second system type not available list 112. Upon determining that system-G is in the second system type not available list 112, the wireless communication device 102 then determines whether the timer 122 is running. At this point, the timer 122 is still running Upon determining that the timer 122 has expired (at the end of the second period 758b), the wireless communication device 102 scans 740d for second system type systems. Upon failing 754e to find a second system type system, the wireless communication device 102 repeats the scanning cycle.

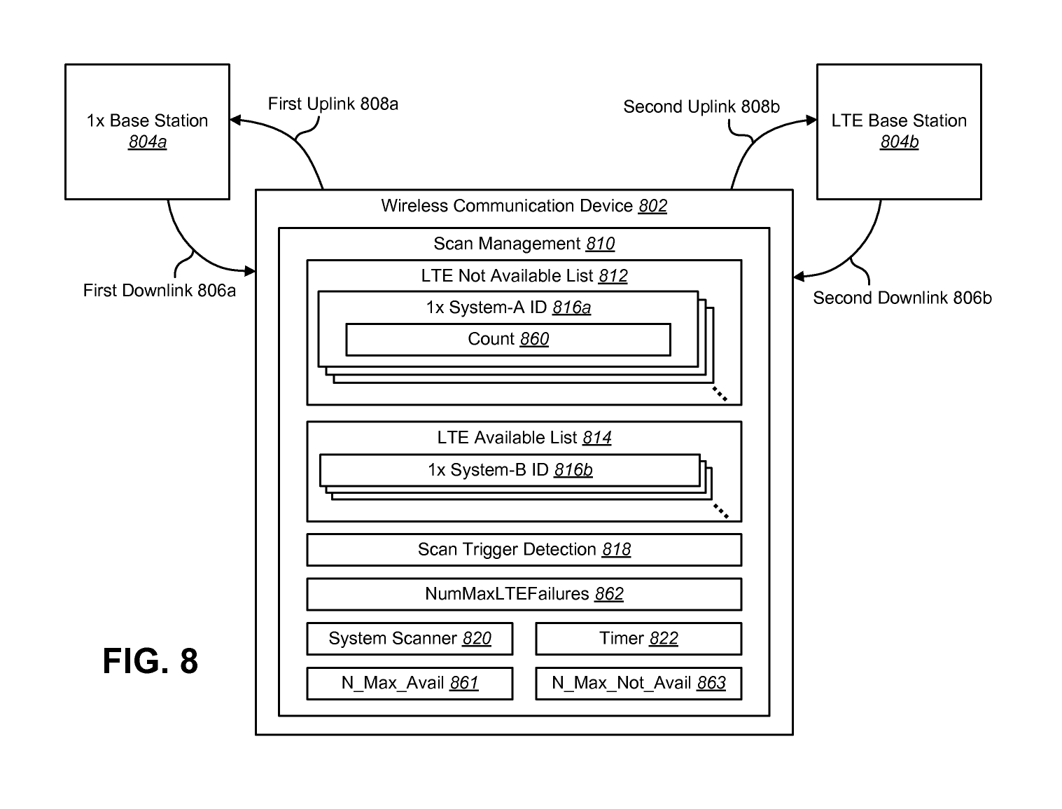

FIG. 8 is a block diagram illustrating one configuration of a wireless communication device 802, a 1× base station 804a and an LTE base station 804b in which systems and methods for efficient wireless system scanning may be implemented. The wireless communication device 802 may be similar to the wireless communication device 102 described in FIG. 1. The 1× base station 804a may correspond to the first system type base station 104a (where the first system type is a 1× system) and the LTE base station 804b may correspond to the second system type base station 104b (where the second system type is an LTE system).

The wireless communication device 802 may communicate with the 1× base station 804a on a first downlink 806a and/or a first uplink 808a. The wireless communication device 802 may also communicate with the LTE base station 804b on a second downlink 806b and/or a second uplink 808b.

The wireless communication device 802 may include a scan management block/module 810. The scan management block/module 810 may manage better system reselection (BSR) scans according to the system and methods described herein. In one configuration, the scan management block/module 810 may include a system scanner block/module 820 for performing BSR scans for LTE systems. In some configurations, the system scanner block/module 820 may perform BSR scans upon the expiration of a timer 822. It should also be noted that one or more of the elements illustrated in FIG. 8 may be implemented in circuitry (e.g., integrated circuitry) in some configurations.

The scan management block/module 810 may maintain two lists 812, 814. An LTE not available list 812 may correspond to the second system type not available list 112 described above in connection with FIG. 1. An LTE available list 814 may correspond to the second system type available list 114 also described above in connection with FIG. 1.

Each list 812, 814 may include entries 816 corresponding to 1× base stations 804a. In one configuration, the LTE not available list 812 may include a 1× system-A ID 816a and/or other entries corresponding to other 1× base stations 104a. The LTE available list 814 may include a 1× system-B ID 816b and/or other entries corresponding to other 1× base stations 104a. Each 1× system ID 816 may include identifying information for a particular 1× base station 804a.

The 1× System IDs 816 may be ordered in a most-recently used fashion. For example, the 1× System-A ID 816a may be the most recent entry to the LTE not available list 812. Therefore, the 1× System-A ID 816a may be added to the top of the LTE not available list 812.

The scan management block/module 810 may include an N_Max_Avail parameter 861, which may indicate the maximum number of 1× System IDs 816 that may be entered into the LTE available list 814. If the LTE available list 814 has the maximum number of 1× System IDs 816, the bottom-most entry may be removed (e.g., deleted) from the LTE available list 814. Similarly, the scan management block/module 810 may include an N_Max_Not_Avail parameter 863, which may indicate the maximum number of 1× System IDs 816 that may be entered into the LTE not available list 812.

The LTE available list 814 may include 1× systems (e.g., 1× System IDs 816) where the wireless communication device 802 has previously acquired LTE service during a BSR scan. In other words, the LTE available list 814 may be a list of 1× base stations 804a that the wireless communication device 802 is currently or has previously camped on when an LTE base station 804b was discovered. The LTE available list 814 may also be referred to as an LTEAvailableFile or LTE_AVAIL_LST.

The LTE not available list 812 may include 1× systems (e.g., 1× system IDs 816) where the wireless communication device 802 has camped, but a BSR scan for LTE systems while camped on the 1× system has never found an LTE base station 804b. In other words, the LTE not available list 812 may include a list of 1× base stations 804a that the wireless communication device 802 is currently or has previously camped on and from which the wireless communication device 802 has never been able to find LTE base station 804b. The LTE not available list 812 may also be referred to as an LTENotAvailableFile or LTE_NOT_AVAIL_LST.

The scan trigger detection block/module 818 may detect one or more scan triggers that indicate to the wireless communication device 802 that the wireless communication device 802 should perform a scan for a preferred LTE base station 804b. The scan triggers may include a call end, an idle handover, a power-up of the wireless communication device 802, an out-of-service change and/or a mode change. The scan trigger detection block/module 818 may detect one or more scan triggers as described above in connection with FIG. 1.

If the scan trigger detection block/module 818 detects a scan trigger (e.g., a call end, an idle handover, a redirection, etc.) to perform an immediate BSR (IBSR) scan, the wireless communication device 802 may perform the immediate BSR scan only if camped on a 1× system that is not in the LTE not available list 812. Subsequently, the wireless communication device 802 may scan for more preferred LTE systems per the steady-state rules.

The LTE not available list 812 may also be used to distinguish between 1× systems that the wireless communication device 802 has camped on in the past where LTE was not acquired, and 1× systems on which the wireless communication device 802 is camping for the first time. For example, the LTE not available list 812 may allow for avoiding slow BSR scans for LTE when the wireless communication device 802 is first sold and the LTE available list 814 is being built up. The LTE not available list 812 may also allow for avoiding slow scans for LTE when the wireless communication device 802 moves to a new region (e.g., from the coverage area 324 of one 1× base station 804a to the coverage area 324 of another 1× base station 804a).

A 1× system may be added to one of the lists 812, 814 after a BSR scan is performed. A BSR scan may be performed immediately (instead of waiting the normal BSR scan period) or may be performed after a certain period of time. For example, a normal BSR scan period (e.g., BSR period) may correspond to the first period and the long BSR scan period (e.g., LBSR period) may correspond to the second period described above in connection with FIG. 1. Therefore, the time between scans for a LBSR scan may be a longer than the time between BSR scans. In other words, with LBSR, the more preferred LTE systems are scanned less frequently.

When the wireless communication device 802 is camped on a 1× system that is not listed in the LTE not available list 812, the wireless communication device 802 may scan for more preferred LTE systems after every BSR cycle (e.g., BSR period). It should be noted that wireless communication device 802 may also scan for LTE systems during every BSR cycle when it is in an area with data optimized (DO) only coverage.

When the wireless communication device 802 is camped on a 1× system that is listed in the LTE not available list 812, the wireless communication device 802 may not scan for more preferred LTE systems after every BSR cycle (e.g., BSR period). Instead, during a LSBR period, the more preferred LTE systems may only be scanned every nth BSR scan attempt, where n is the next LTE scan divided by the BSR period (nextLTEScan/BSR period). For example, if the BSR period is 3 minutes and nextLTEScan is set to 60 minutes, during an LBSR period, LTE is scanned only during BSR #1, BSR#21, BSR#41, etc. It should be noted that during an LBSR period, BSR scans for other more preferred systems may take place without changes.

If a BSR scan is performed while a wireless communication device 802 is camped on a 1× system and an LTE system is found, the 1× system ID 816 may be added to the top of the LTE available list 814 (or moved to the top if the 1× system ID 816 is already listed in the LTE available list 814). If the LTE available list 814 has the maximum number of entries (e.g., N_max_avail 861) and the 1× system ID 816 is a new entry, the bottom-most entry may be removed from the LTE available list 814.

If the BSR scan does not find an LTE system and the 1× system ID 816 is not listed in the LTE not available list 812, the 1× system ID 816 may be added to the top of the LTE not available list 812. If the LTE not available list 812 has the maximum number of entries (e.g., N_max_not_avail 863), the bottom-most entry may be removed from the LTE not available list 812. If the BSR scan does not find an LTE system and the 1× system ID 816 is already in the LTE not available list 812, the 1× system ID 816 may be moved to the top of the LTE not available list 812. Once a 1× system is added to the LTE available list 814, the 1× system is not moved to the LTE not available list 812 even if a subsequent BSR scan while camped on the 1× system fails to find an LTE system.

After an Open Mobile Alliance Device Management (OMA-DM) update, it may be desirable to clear the LTE available list and the LTE not available list. For example, the Multi-Mode System Selection (MMSS) files or other settings may have been changed during the update. Since the advanced multimode subscriber software (AMSS) does not know which files have changed as part of the OMA-DM update, it may be necessary for the service provider to determine which files are to be reset after such an update.

Experience with previous LTE launches has shown that initial deployments may have fringe areas where the availability and non-availability of LTE systems vary significantly within short distances. In order to avoid situations where the wireless communication device 802 is too aggressive in using an LBSR period, the scan management block/module 810 may include a NumMaxLTEFailures configuration parameter 862. The NumMaxLTEFailures configuration parameter 862 may allow the wireless communication device 802 to use failed BSR scan attempts for LTE systems to determine that the wireless communication device 802 is in a region without LTE and use successful BSR scan attempts/Simultaneous Voice-LTE (SV-LTE) camping to determine that the wireless communication device 802 is in a region with LTE. The NumMaxLTEFailures configuration parameter 862 may provide flexibility to the systems and methods used to generate the LTE not available list 812.

A count field 860 may be included in each 1× system (e.g., 1× base station 804a) in the LTE not available list 812. The count field 860 may be incremented each time a BSR scan for LTE systems fails while camped on the 1× base station 804a. Thus, the count field 860 for a 1× base station 804a may initially be set to zero when the 1× base station 804a is added to the LTE not available list 812. If the wireless communication device 802 is camped on a 1× base station 804a in the LTE not available list 812, the wireless communication device 802 may determine whether the count field 860 for the 1× base station 804a is less than the NumMaxLTEFailures configuration parameter 862. If the count field 860 for the 1× base station 804a is less than the NumMaxLTEFailures configuration parameter 862, a normal BSR period may be used by the wireless communication device 802. If the count field 860 for the 1× base station 804a is greater than or equal to the NumMaxLTEFailures configuration parameter 862, the wireless communication device 802 may use a longer BSR (LBSR) period. The initial value of the NumMaxLTEFailures configuration parameter 862 may be set to 1. However, field testing may allow for adjustment of the NumMaxLTEFailures configuration parameter 862 to account for situations where using a NumMaxLTEFailures configuration parameter 862 is too aggressive (and thus leads to slow discovery of LTE systems) in some areas.

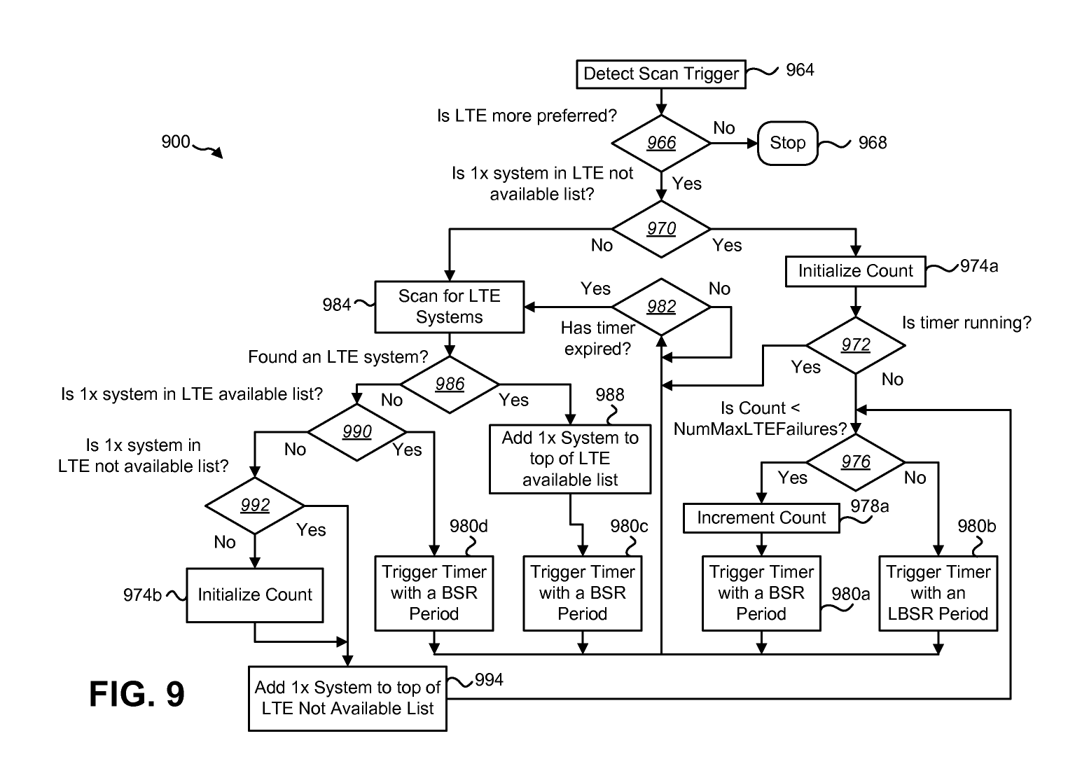

FIG. 9 is a flow diagram illustrating an even more specific configuration of a method 900 for efficient wireless system scanning The method 900 may be performed by a wireless communication device 802. The wireless communication device 802 may be camped on a 1× system. For example, the wireless communication device 802 may be connected to a 1× base station 804a. The wireless communication device 802 may maintain an LTE not available list 812 and an LTE available list 814.

The wireless communication device 802 may detect 964 a scan trigger. The scan trigger may include a call end, an idle handover, a power-up of the wireless communication device 802, an out-of-service change and/or a mode change. The scan trigger may indicate to the wireless communication device 802 that an event or a change in conditions has occurred for which a BSR scan for an LTE base station 804b may be desirable.

Upon detecting 964 the scan trigger, the wireless communication device 802 may determine 966 whether LTE is more preferred. If LTE is not more preferred, then the method 900 stops 968 without the wireless communication device 802 performing a BSR scan for LTE systems (e.g., LTE base station 804b). If LTE is more preferred, then the wireless communication device 802 may determine 970 whether the 1× system is in the LTE not available list 812. For example, the wireless communication device 802 may determine 970 whether the LTE not available list 812 includes a 1× system ID 816 corresponding to the 1× base station 804a.

If the wireless communication device 802 determines 970 that the 1× system is in the LTE not available list 812, then the wireless communication device 802 may initialize 974a the count 860. The count 860 may be set to zero.

The wireless communication device 802 may determine 972 whether a timer 822 is running If the wireless communication device 802 determines 972 that the timer 822 is running, then the wireless communication device 802 may wait until the timer 822 expires. When the wireless communication device 802 determines 982 that the timer 822 has expired, the wireless communication device 802 may perform a BSR scan 984 for LTE systems.

If the wireless communication device 802 determines 972 that the timer 822 is not running, the wireless communication device 802 may determine 976 whether the count 860 is less than the NumMaxLTEFailures 862. If the count 860 is less than the NumMaxLTEFailures 862, then the count 860 may be incremented 978a. For example, the count 860 may be incremented by 1. The timer 822 may be triggered 980a with a BSR period. The BSR period may be the amount of time before a BSR scan 984 for LTE systems may be performed. The BSR period may also correspond to a normal BSR scan cycle. A BSR scan 984 for LTE systems may be performed upon the expiration of the timer 822 (e.g., at the expiration of the BSR period).

If the wireless communication device 802 determines 976 that the count 860 is not less than the NumMaxLTEFailures 862, then the timer 822 may be triggered 980b with an LBSR period. The LBSR period may correspond to a long BSR scan cycle. In other words, the LBSR period may slow down the amount of time between BSR scans. Upon the expiration of the timer 822 (e.g., at the expiration of the LBSR period) a BSR scan 984 for LTE systems may be performed.

If the wireless communication device 802 determines 970 that the 1× system is not in the LTE not available list 812, then the wireless communication device 802 may perform an immediate BSR scan 984 for LTE systems. In one implementation, the wireless communication device 802 may bypass the timer 822 and perform an immediate scan 984 for LTE systems. In another configuration, the wireless communication device 802 may trigger the timer 822 with an immediate BSR period (e.g., the period for the timer 822 may be set to zero seconds), which will trigger an immediate scan 984 for LTE systems.

Upon scanning 984 for LTE systems, the wireless communication device 802 may determine 986 whether an LTE system is found. If an LTE system (e.g., the LTE base station 804b) is found, then the wireless communication device 802 may add 988 (and/or move) the 1× system to the top of the LTE available list 814. In one configuration, the wireless communication device 802 may add 988 a 1× system ID 816 to the LTE available list 814. The 1× system ID 816 may include identifying information (e.g., a combination of system ID (SID), network ID (NM) and/or base station ID (BASE_ID)) for a particular first system type base station 804a. In one configuration, adding 988 the 1× system to the top of the LTE available list 814 may also include removing the 1× system from the LTE not available list 812.

Upon adding 988 the first system to the top of the LTE available list 814, the wireless communication device 802 may trigger 980c the timer 822 with a BSR period. A scan 984 for LTE systems may be performed upon the expiration of the timer 822 (e.g., at the expiration of the BSR period).

If the wireless communication device 802 determines 986 that an LTE system is not found, then the wireless communication device 802 may determine 990 if the 1× system is in the LTE available list 814. If the first system is in the LTE available list 814, then the wireless communication device 802 may trigger 980d the timer 822 with a BSR period. A scan 984 for LTE systems may be performed upon the expiration of the timer 822 (e.g., at the expiration of the BSR period).

If the wireless communication device 802 determines 990 that the 1× system is not in the LTE available list 814, then the wireless communication device 802 may determine 992 whether the 1× system is in the LTE not available list 812. If the 1× system is in the LTE not available list 812, then the wireless communication device 802 may add 994 (and/or move) the 1× system to the top of the LTE not available list 812. If the 1× system is not in the LTE not available list 812 (because the wireless communication device 802 has never camped on the 1× system before), then the count 860 may be initialized 974b and the 1× system may be added 994 to the top of the LTE not available list 812. The wireless communication device 802 may then determine 976 whether the count 860 is still less than NumMaxLTEFailures 862.

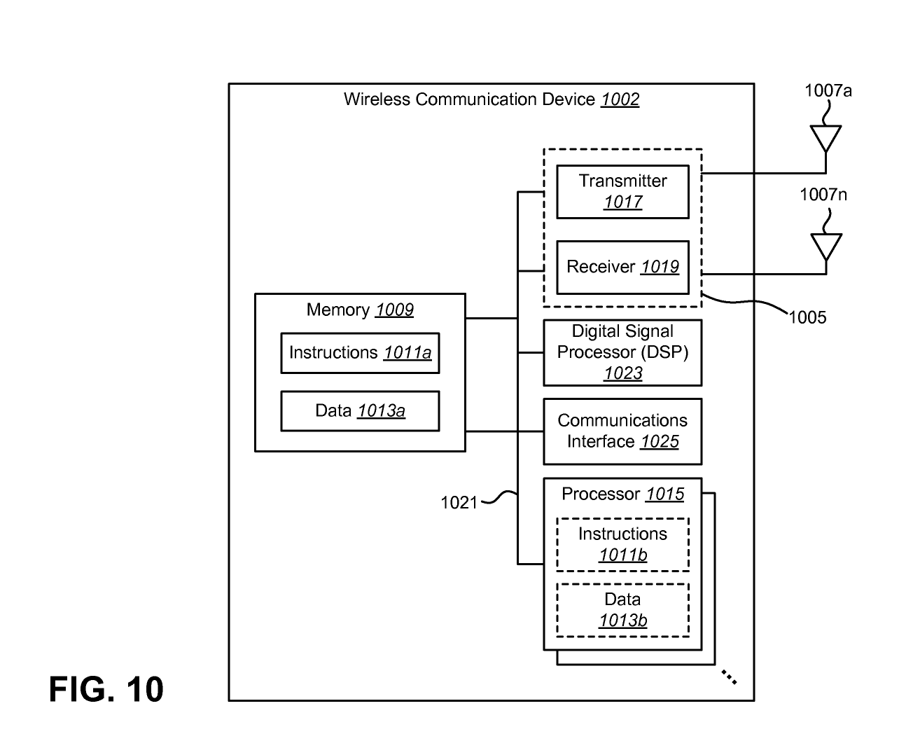

FIG. 10 illustrates certain components that may be included within a wireless communication device 1002. The wireless communication device 1002 may be implemented in accordance with one or more of the wireless communication devices 102, 302 and 802 described above. The wireless communication device 1002 may be an access terminal, a mobile station, a user equipment, etc. The wireless communication device 1002 includes one or more processors 1015. The one or more processors 1015 may be a general purpose single- or multi-chip microprocessor (e.g., an ARM), a special purpose microprocessor (e.g., a digital signal processor (DSP)), a microcontroller, a programmable gate array, etc.). The one or more processors 1015 may be referred to as a central processing unit (CPU). In one configuration, the one or more processors 1015 may include a single processor 1015. For example, the single processor 1015 may provide multiple functions (e.g., an ARM, DSP, modem processing and applications processing). In another configuration, the one or more processors 1015 may include multiple separate processors 1015 (e.g., separate chips). For example, one processor 1015 may be a modem (e.g., baseband) processor and another processor 1015 may be an applications processor.

The wireless communication device 1002 also includes memory 1009. The memory 1009 may be any electronic component capable of storing electronic information. The memory 1009 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 1013a and instructions 1011a may be stored in the memory 1009. The instructions 1011a may be executable by the processor 1015 to implement the methods disclosed herein. Executing the instructions 1011a may involve the use of the data 1013a that is stored in the memory 1009. When the processor 1015 executes the instructions 1011a, various portions of the instructions 1011b may be loaded onto the processor 1015, and various pieces of data 1013b may be loaded onto the processor 1015.

The wireless communication device 1002 may also include a transmitter 1017 and a receiver 1019 to allow transmission and reception of signals to and from the wireless communication device 1002. The transmitter 1017 and receiver 1019 may be collectively referred to as a transceiver 1005. Multiple antennas 1007a-n may be electrically coupled to the transceiver 1005. The wireless communication device 1002 may also include (not shown) multiple transmitters, multiple receivers, multiple transceivers and/or additional antennas.

The wireless communication device 1002 may include a digital signal processor (DSP) 1023. The wireless communication device 1002 may also include a communications interface 1025. The communications interface 1025 may allow a user to interact with the wireless communication device 1002.

The various components of the wireless communication device 1002 may be coupled together by one or more buses, which may include a power bus, a control signal bus, a status signal bus, a data bus, etc. For the sake of clarity, the various buses are illustrated in FIG. 10 as a bus system 1021.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “couple” and any variations thereof may indicate a direct or indirect connection between elements. For example, a first element coupled to a second element may be directly connected to the second element, or indirectly connected to the second element through another element.

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 2, 4 and 9, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for scanning for wireless systems, comprising:
camping on a first system of a first system type;
maintaining a second system type not available list;
maintaining a second system type available list;
detecting a scan trigger;
determining whether the first system is in the second system type not available list; and
scanning for second system type systems based on a timer.

2. The method of claim 1, wherein the scan trigger is selected from a group consisting of a call end, an idle handover, a power-up, an out-of-service change, and a mode change.

3. The method of claim 1, wherein if the first system is in the second system type not available list, then the method further comprises triggering the timer with a first period, wherein the scan is performed upon expiration of the first period.

4. The method of claim 3, further comprising determining whether the timer has expired before triggering the timer.

5. The method of claim 1, wherein if the first system is not in the second system type not available list, then the method further comprises performing an immediate scan for second system type systems.

6. The method of claim 5, wherein if a system of the second system type is found, then the method further comprises:
adding the first system to a top of the second system type available list; and
triggering the timer with a first period, wherein a second scan is performed upon expiration of the first period.

7. The method of claim 6, further comprising removing the first system from the second system type not available list.

8. The method of claim 5, wherein if a system of the second system type is found, then the method further comprises:
determining whether the first system is in the second system type available list;
moving the first system to a top of the second system type available list; and
triggering the timer with a first period, wherein a second scan is performed upon expiration of the first period.

9. The method of claim 5, wherein if a system of the second system type is not found, then the method further comprises determining whether the first system is in the second system type available list.

10. The method of claim 9, wherein if the first system is in the second system type available list, then the method further comprises triggering the timer with a first period, wherein a second scan is performed upon expiration of the first period.

11. The method of claim 9, wherein if the first system is not in the second system type available list, then the method further comprises:
adding the first system to a top of the second system type not available list; and
triggering the timer with a second period, wherein a second scan is performed upon expiration of the second period.

12. The method of claim 1, wherein the second system type not available list comprises a count field, and wherein the method further comprises determining whether the count field is less than a configuration parameter corresponding to a maximum number of scan failures.

13. The method of claim 12, wherein if the count field is less than the configuration parameter, then the method further comprises:
incrementing the count field; and
triggering the timer with a first period, wherein the scan is performed upon expiration of the first period.

14. The method of claim 12, wherein if the count field is not less than the configuration parameter, then the method further comprises:
triggering the timer with a second period, wherein the scan is performed upon expiration of the second period.

15. The method of claim 1, wherein the method is performed by a wireless communication device.

16. The method of claim 1, wherein the first system type is 1× and the second system type is long term evolution (LTE).

17. The method of claim 1, wherein the scan comprises a better system reselection scan.

18. A wireless communication device for scanning for wireless systems, comprising:
a processor;
memory in electronic communication with the processor; and
instructions stored in the memory, the instructions being executable by the processor to:
camp on a first system of a first system type;
maintain a second system type not available list;
maintain a second system type available list;
detect a scan trigger;
determine whether the first system is in the second system type not available list; and
scan for second system type systems based on a timer.

19. The wireless communication device of claim 18, wherein the scan trigger is selected from a group consisting of a call end, an idle handover, a power-up, an out-of-service change, and a mode change.

20. The wireless communication device of claim 18, wherein if the first system is in the second system type not available list, then the instructions are further executable to trigger the timer with a first period, wherein the scan is performed upon expiration of the first period.

21. The wireless communication device of claim 20, further comprising instructions executable to determine whether the timer has expired before triggering the timer.

22. The wireless communication device of claim 18, wherein if the first system is not in the second system type not available list, then the instructions are further executable to perform an immediate scan for second system type systems.

23. The wireless communication device of claim 22, wherein if a system of the second system type is found, then the instructions are further executable to:
add the first system to a top of the second system type available list; and
trigger the timer with a first period, wherein a second scan is performed upon expiration of the first period.

24. The wireless communication device of claim 23, further comprising instructions executable to remove the first system from the second system type not available list.

25. The wireless communication device of claim 22, wherein if a system of the second system type is found, then the instructions are further executable to:
determine whether the first system is in the second system type available list;
move the first system to a top of the second system type available list; and
trigger the timer with a first period, wherein a second scan is performed upon expiration of the first period.

26. The wireless communication device of claim 22, wherein if a system of the second system type is not found, then the instructions are further executable to determine whether the first system is in the second system type available list.

27. The wireless communication device of claim 26, wherein if the first system is in the second system type available list, then the instructions are further executable to trigger the timer with a first period, wherein a second scan is performed upon expiration of the first period.

28. The wireless communication device of claim 26, wherein if the first system is not in the second system type available list, then the instructions are further executable to:
add the first system to a top of the second system type not available list; and
trigger the timer with a second period, wherein a second scan is performed upon expiration of the second period.

29. The wireless communication device of claim 18, wherein the second system type not available list comprises a count field, and wherein the instructions are further executable to determine whether the count field is less than a configuration parameter corresponding to a maximum number of scan failures.

30. The wireless communication device of claim 29, wherein if the count field is less than the configuration parameter, then the instructions are further executable to:
increment the count field; and
trigger the timer with a first period, wherein the scan is performed upon expiration of the first period.

31. The wireless communication device of claim 29, wherein if the count field is not less than the configuration parameter, then the instructions are further executable to:
trigger the timer with a second period, wherein the scan is performed upon expiration of the second period.

32. The wireless communication device of claim 18, wherein the first system type is 1× and the second system type is long term evolution (LTE).

33. A computer-program product for scanning for wireless systems, comprising a non-transitory tangible computer-readable medium having instructions thereon, the instructions comprising:
code for causing a wireless communication device to camp on a first system of a first system type;
code for causing a wireless communication device to maintain a second system type not available list;
code for causing a wireless communication device to maintain a second system type available list;
code for causing a wireless communication device to detect a scan trigger;
code for causing a wireless communication device to determine whether the first system is in the second system type not available list; and
code for causing a wireless communication device to scan for second system type systems based on a timer.

34. The computer-program product of claim 33, wherein if the first system is in the second system type not available list, then the instructions further comprise code for causing a wireless communication device to trigger the timer with a first period, wherein the scan is performed upon expiration of the first period.

35. The computer-program product of claim 33, wherein if the first system is not in the second system type not available list, then the instructions further comprise code for causing a wireless communication device to perform an immediate scan for second system type systems.

36. The computer-program product of claim 35, wherein if a system of the second system type is found, then the instructions further comprise code for causing a wireless communication device to:
add the first system to a top of the second system type available list; and trigger the timer with a first period, wherein a second scan is performed upon expiration of the first period.

37. The computer-program product of claim 35, wherein if a system of the second system type is not found, then the instructions further comprise code for causing a wireless communication device to determine whether the first system is in the second system type available list.

38. The computer-program product of claim 37, wherein if the first system is not in the second system type available list, then the instructions further comprise code for causing a wireless communication device to:
add the first system to a top of the second system type not available list; and
trigger the timer with a second period, wherein a second scan is performed upon expiration of the second period.

39. An apparatus for scanning for wireless systems, comprising:
means for camping on a first system of a first system type;
means for maintaining a second system type not available list;
means for maintaining a second system type available list;
means for detecting a scan trigger;
means for determining whether the first system is in the second system type not available list; and
means for scanning for second system type systems based on a timer.

40. The apparatus of claim 39, wherein if the first system is in the second system type not available list, then the apparatus further comprises means for triggering the timer with a first period, wherein the scan is performed upon expiration of the first period.

41. The apparatus of claim 39, wherein if the first system is not in the second system type not available list, then the apparatus further comprises means for performing an immediate scan for second system type systems.

42. The apparatus of claim 41, wherein if a system of the second system type is found, then the apparatus further comprises:
means for adding the first system to a top of the second system type available list; and
means for triggering the timer with a first period, wherein a second scan is performed upon expiration of the first period.

43. The apparatus of claim 41, wherein if a system of the second system type is not found, then the apparatus further comprises means for determining whether the first system is in the second system type available list.

44. The apparatus of claim 43, wherein if the first system is not in the second system type available list, then the apparatus further comprises:
means for adding the first system to a top of the second system type not available list; and
means for triggering the timer with a second period, wherein a second scan is performed upon expiration of the second period.
